(19) United States
(12) Patent Application Publication
(10) Pub. No.: US 2010/0233073 A1
(43) Pub. Date: Sep. 16, 2010

(54) Manufacturing Method of Highly Pure Alpha-LiAlO2

(75) Inventors: Sang Hoon Hyun, Seoul (KR); Hyun Jong Cho, Seoul (KR); Jong Jin Lee, Seoul (KR)

Correspondence Address: LEXYOUME IP GROUP, LLC, 5180 PARKSTONE DRIVE, SUITE 175, CHANTILLY, VA, 20151, US

(73) Assignee: Industry-Academic Cooperation Foundation, Younsei University, Seoul (KR)

(21) Appl. No.: 12/593,046

(22) PCT Filed: Aug. 5, 2008
(86) PCT No.: PCT/KR08/04546

§ 371 Date: Sep. 30, 2009

(30) Foreign Application Priority Data
Nov. 29, 2007 (KR) 10-2007-0122808

(51) Int. Cl. C01F 7/04

(52) U.S. Cl. 423/600

(57) ABSTRACT

The present invention relates to a method for preparing high-purity alpha-lithium aluminate (α-LiAlO₂). More specifically, the invention relates to a method for preparing alpha-lithium aluminate, which comprises mixing Al(OH)₃ and Li₂CO₃ at a molar ratio of from 1:1 to 3:1 and heat-treating the mixture at a temperature of 500-800° C. and which can prepare high-purity alpha-lithium aluminate without needing to carry out a washing process.

### TECHNICAL FIELD

The present invention relates to a method for preparing high-purity alpha-lithium aluminate α-LiAlO₂, and more particularly to a method for preparing alpha-lithium aluminate, which comprises mixing Al(OH)₃ and Li₂CO₃ at a molar ratio of from 1:1 to 3:1 and heat-treating the mixture at a temperature of 500-800° C. and which can prepare high-purity alpha-lithium aluminate without needing to carry out a washing process.

### BACKGROUND ART

In line with industrial development and economic growth, the demand for electric power in Korea is rapidly increasing, yet energy resources required therefor are mostly imported from foreign countries, and this state will continue unchanged into the future. Thus, the effective utilization of energy and the security of energy resources are important issues alongside that of the generation of electric power. However, environmental problems such as environmental pollution and climate change arising from the use of fossil fuels such as petroleum and coal, needed to produce electric power, are becoming more serious day by day. Thus, in order to solve various environmental pollution problems, such as global warming arising from the generation of carbon dioxide, attention is being focused on clean energy sources, such as sunlight, solar energy, bio-energy, wind power energy and hydrogen energy. Among them, the field of fuel cells which use hydrogen as a fuel is also being actively studied.

Fuel cells are environmentally friendly, because exhaust gases therefrom are very clean. Also, fuel cells show high efficiency even in small volume, and can effectively utilize waste heat, thus improving their total energy efficiency. Such fuel cells are becoming representative new energy sources, and thus the use thereof will be rapidly popularized.

Examples of the fuel cells include phosphoric acid fuel cells, molten carbonate fuel cells, solid oxide fuel cells, alkaline fuel cells, etc. Among them, molten carbonate fuel cells utilize as an electrolyte a mixed molten salt of lithium carbonate (Li₂CO₃) with potassium carbonate (K₂CO₃), in which the molar ratio of Li₂CO₃:K₂CO₃ is generally 62:38. In some cases, sodium carbonate (Na₂CO₃) is added to the electrolyte.

Electric charge which participates in electrode reactions in the molten carbonate fuel cells arises from carbonate ion (CO₃²⁻) which is in the form of an oxide ion (O²⁻) added to carbon dioxide. When hydrogen is used as fuel, carbon dioxide is generated in the anode, and thus carbonate ions in the electrolyte decrease. Accordingly, carbon dioxide being generated must be oxidized with oxygen back to carbonate ions, and thus the overall reaction formula becomes the water production equation as follows:

H₂+CO₃²⁻→2H₂O+CO₂+2e−+O₂+2CO₂+4e−→2CO₃²⁻

CO+CO₃²⁻→2CO₂+2e−

Lithium aluminate which is produced according to this reaction formula is mostly gamma-lithium aluminate (γ-LiAlO₂), but in some cases, gamma-lithium aluminate together with alpha-lithium aluminate (α-LiAlO₂) is produced. However, gamma-lithium aluminate is unstable compared to alpha-lithium aluminate, and thus a molten carbonate fuel cell manufactured using gamma-lithium aluminate has a problem in that defects are likely to occur in the matrix due to the phase transition of gamma-lithium aluminate during operation.

When a single γ-LiAlO₂ sample and a mixed sample of α-/γ-LiAlO₂ are heat-treated, the lithium (Li) component is dissolved from the initial stage of heat treatment, and thus two allotropic forms of lithium sodium carbonate (LiNaCO₃) are synthesized and deposited as impurities. With the passage of time during heat treatment, in the single γ-LiAlO₂ sample, a LiNaCO₃ phase is produced, but no change occurs in the γ-LiAlO₂ peak. In contrast, in the α-/γ-LiAlO₂ mixed sample, the peak of α-LiAlO₂ does not change, but the peak of γ-LiAlO₂ decreases while the peak of LiNaCO₃ continuously increases. Thus, it can be seen that lithium (Li) is taken mainly from γ-LiAlO₂ to synthesize LiNaCO₃.

On the other hand, in the case of a single α-LiAlO₂ sample, there is no great change in particle size and specific surface area, when it is maintained in a molten carbonate of Li₂CO₃/Na₂CO₃ (molar ratio=52:48) at 650° C. for 6000 hours, which are the operating conditions of a molten carbonate fuel cell, and a reaction product such as LiNaCO₃ is not produced. Thus, it can be seen that the α-LiAlO₂ is much superior to the γ-LiAlO₂ phase with respect to long-term stability. Also, it can be seen that γ-LiAlO₂ in the mixed sample of α-/γ-LiAlO₂ is dissolved in molten carbonate to produce the LiNaCO₃ phase.

Namely, γ-LiAlO₂ has problems in that it is unstable, and has a high possibility of transition to other phases which act as impurities in the matrix of a fuel cell, thus deteriorating the performance of the fuel cell.

Also, the above-described electrolytes (carbonates) have problems in that they act as impurities in the final product of lithium aluminate, and thus a process for washing these impurities is necessarily required, and furthermore, impurities can be introduced during the washing process.

Accordingly, it is preferable to use alpha-lithium aluminate α-LiAlO₂) having excellent phase stability as the matrix of a molten carbonate fuel cell. However, the alpha-lithium aluminate has a problem of relatively high production cost. Thus, there is an urgent need to develop a technology capable of synthesizing alpha-lithium aluminate at low cost or develop a novel material for matrices, which has excellent phase/microstructure stability in molten carbonate and is inexpensive.

### DISCLOSURE OF INVENTION

### Technical Problem

The present invention has been made in order to solve the above-described problems occurring in the prior art, and it is an object of the present invention to enable alpha-lithium aluminate to be prepared in an inexpensive manner in a large amount per unit of time by eliminating the addition of carbonate during the synthesis thereof to eliminate the need to carry out a washing process.

Another object of the present invention is to prepare alpha-lithium aluminate in high purity by eliminating the risk of occurrence of impurities which can be introduced by conducting a washing process for removing carbonate added during the synthesis of alpha-lithium aluminate.

Still another object of the present invention is to prevent the production of agglomerates of alpha-lithium aluminate particles, which can occur during a washing process, thus increasing the specific surface area of the particles and greatly increasing the strength of a fuel cell matrix manufactured from the particles.

### Technical Solution

To achieve the above objects, the present invention provides a method for preparing alpha-lithium aluminate, which comprises the steps of: mixing Al(OH)₃ with Li₂CO₃ at a molar ratio of from 1:1 to 3:1; and heat-treating the mixture at a temperature range of 500-800° C.

In the method of the present invention, the step of heat-treating the mixture is preferably carried out in an atmosphere of CO₂.

Also, the heat-treatment step comprises heating the mixture at a rate of 3-6° C./min and maintaining the mixture in the temperature range.

### ADVANTAGEOUS EFFECTS

According to the present invention, alpha-lithium aluminate can be prepared in an inexpensive manner in a large amount per unit of time by eliminating the addition of carbonate during the synthesis thereof to eliminate the need to carry out a washing process.

Also, alpha-lithium aluminate can be prepared in high purity by preventing impurities from being introduced during a washing process for removing carbonate added during the synthesis of alpha-lithium aluminate.

In addition, the production of agglomerates of alpha-lithium aluminate particles, which can occur during a washing process, is prevented, thus increasing the specific surface area of the particles and greatly increasing the strength of a fuel cell matrix manufactured from the particles.

### BRIEF DESCRIPTION OF DRAWINGS

FIG. 1 shows the phase formation of alpha-lithium aluminate at various temperatures.

FIG. 2 shows XRD data for particles synthesized from the compositions shown in Table 2.

FIG. 3 shows XRD data for particles synthesized from composition No. 7 of Table 7 at various temperatures.

FIG. 4 shows XRD data for alpha-lithium aluminate synthesized according to the present invention.

FIG. 5 shows XRD data for alpha-lithium aluminate synthesized according to the present invention using carbonate.

### BEST MODE FOR CARRYING OUT THE INVENTION

Hereinafter, the present invention will be described in further detail with reference to examples.

### Example 1

### Synthesis of Alpha-Lithium Aluminate Using Aqueous Matrix Compositions

During a process for developing an aqueous matrix, the present inventors have found that α-LiAlO₂ can be synthesized at 450° C. in the case of an aqueous matrix. Based in this finding, the aqueous tape-casting slurry compositions shown in Table 1 below were prepared, and whether α-LiAlO₂ particles were produced from the compositions at varying heat-treatment temperatures ranging from 450° C. and 650° C., and the influences of composition and temperature on the production of α-LiAlO₂ particles, were observed in order to optimize the conditions in which α-LiAlO₂ particles can be efficiently produced at the lowest temperature. The synthesis of α-LiAlO₂ particles was carried out by uniformly mixing the components shown in Table 1, placing each of the mixtures in an alumina crucible, heating the mixture to 650° C. at a rate of 5° C./min, and then maintaining the mixture at that temperature. A basic reaction mechanism for the synthesis of α-LiAlO₂ particles is shown in the following equations (1) and (2).

Herein, the temperature conditions, the heating rate and the maintenance time are based on an example of the present invention, and the scope of the present invention is not limited thereto.

LiOH+Al(OH)₃→LiAlO₂+2H₂O (1)

C₃H₅(OH)₃+HO(CH₂CH₂O)H+6O₂→7H₂O+5CO₂ (2)

TABLE 1

| Composition | Components (wt %) | | | | | | | |
|---|---|---|---|---|---|---|---|---|
| No. | LiAlO₂ | LiOHH₂O | Al(OH)₃ | Water | NH₄OH | Albumin | Glycerin | Triethyleneglycol |
| 1 | | 19.1 | 35.5 | 45.4 | | | | |
| 2 | | 12 | 22.3 | 28.6 | 1.4 | 14.3 | 7.1 | 14.3 |
| 3 | 57.7 | 8.1 | 15 | 19.2 | | | | |
| 4 | 50 | 7 | 13 | 16.7 | 0.8 | 8.3 | 4.2 | |
| 5 | 50 | 7 | 13 | 16.7 | 0.8 | | 4.2 | 8.3 |
| 6 | 46.5 | 6.5 | 12.1 | 15.5 | | 7.8 | 3.9 | 7.8 |
| 7 | 55 | 7.7 | 14.3 | 15.5 | | | 4.6 | |
| 8 | | 17.1 | 31.8 | 40.8 | | | 10.2 | |
| 9 | | 14.2 | 26.4 | 33.9 | | | 8.5 | 16.9 |

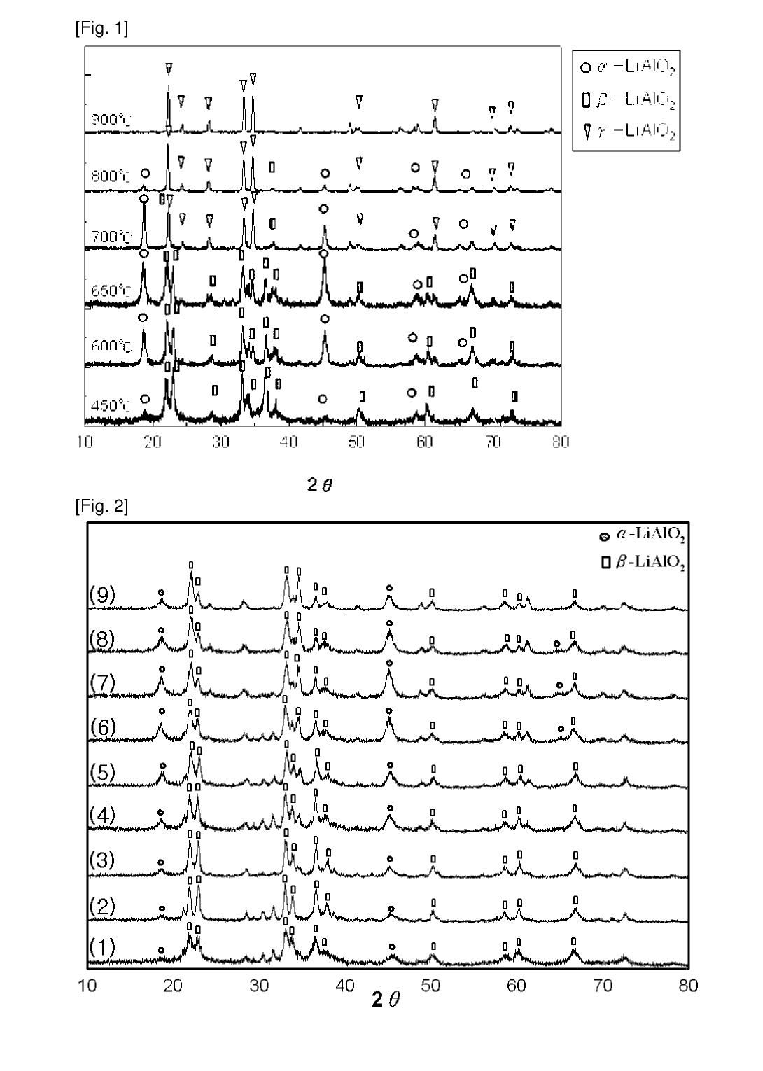

To synthesize α-LiAlO₂ particles, the slurry compositions shown in Table 1 were heat-treated at 650° C. The synthesized LiAlO₂ particles were present in the α, β or γ phase according to the compositions. Specifically, the synthesized LiAlO₂ particles were present in the β and γ phases for composition No. 1, the α and γ phases for composition No. 2, the γ phase for composition No. 3, the α and γ phases for composition Nos. 4, 5, 6 and 7, and the α and β phases for composition Nos. 8 and 9. FIG. 2 shows XRD data for these compositions. As can be seen in FIG. 2, from a comparison between composition No. 1 with composition No. 8 and between composition No. 3 and composition No. 7, it could be seen that glycerin influenced the synthesis of particles during heat treatment. In slurry composition Nos. 8 and 9, LiOH and Al(OH)₃, which are inexpensive materials, were completely synthesized into LiAlO₂ without adding LiAlO₂. For this reason, the slurry composition No. 9 having an α phase peak stronger than that of composition No. 8 was heat-treated at varying temperatures and observed for phase transition. As a result, as can be seen in FIG. 1, at 450° C., α-LiAlO₂ was produced in a mixture with the β phase, and as the temperature was elevated, the β phase was gradually converted to the γ phase which is stable at high temperature. At 600-700° C., the content of α-LiAlO₂ particles reached the highest level, and at 900° C., the α and β particles were all converted to γ particles.

Namely, in the experiment of synthesizing α-LiAlO₂ using the γ-LiAlO₂ slurry compositions for aqueous matrices, it could be seen that factors having a decisive influence on the synthesis of the phase were organic materials. Particularly, when glycerin and triethylene glycon were added to LiOH and Al(OH)₃, which are inexpensive materials, without adding LiAlO₂ thereto, and the mixture was heat-treated, LiOH and Al(OH)₃ were completely synthesized into LiAlO₂, and the α phase was synthesized at 450° C., thus producing a mixed phase of α-/β-LiAlO₂. When the slurry compositions were heat-treated at various temperatures, the XRD peak of α-LiAlO₂ was the strongest at 600-800° C., and as the temperature was increased to 800° C. or alcove, α-LiAlO₂ gradually decreased, and then was completely converted to γ-LiAlO₂ at 900° C.

Thus, it could be seen that the slurry composition heat-treated at a temperature range of 500-800° C. produced high-purity alpha-lithium aluminate.

### Example 2

According to the alcove-described method of synthesizing alpha-lithium aluminate by adding organic materials, the reaction mixture compositions shown in Table 2 below were prepared, and whether α-LiAlO₂ particles were produced from the compositions, and the influence of composition on the production of α-LiAlO₂ particles, were analyzed through SEM images and XRD patterns in order to optimize the conditions in which α-LiAlO₂ particles can be efficiently synthesized using glycerin and triethylene glycol. Also, the produced particles were heat-treated again in an atmosphere of wet CO₂ in order to examine the influence of CO₂ on the production of α-LiAlO₂ particles.

The synthesis of α-LiAlO₂ particles was carried out by uniformly mixing the contents shown in Table 2, placing each of the mixtures in an alumina crucible, subjecting the mixture to a first heat-treatment step of heating the mixture to 650° C. at a rate of 5° C./min and then maintaining the mixture at that temperature for 6 hours, and subjecting the mixture to a second heat-treatment step of heating the mixture to 750° C. at a rate of 5° C./min while blowing a water-containing CO₂ gas and then maintaining the mixture at that temperature for 24-48 hours. Herein, the heating rate may be in the range of 1-6° C./min. A basic reaction mechanism for the synthesis of α-LiAlO₂ particles is shown in the following equations (3) and (4):

LiOH+Al(OH)₃→LiAlO₂+2H₂O (3)

C₃H₅(OH)₃+HO(CH₂CH₂O)H+6O₂→7H₂O+5CO₂ (4)

TABLE 2

| | Components (wt %) | | | | |
|---|---|---|---|---|---|
| Composition | | | DI- | | Triethylene- |
| No. | LiOHH₂O | Al(OH)₃ | Water | Glycerin | glycol |
| 1 | 17.1 | 31.8 | 40.8 | 10.2 | — |
| 2 | 15.5 | 28.9 | 37.1 | — | 18.5 |
| 3 | 14.2 | 26.4 | 33.9 | 8.5 | 16.9 |
| 4 | 16.4 | 30.4 | 19.6 | 11.8 | 21.8 |
| 5 | 15.3 | 28.5 | 18.3 | 13.3 | 24.6 |
| 6 | 13.4 | 24.8 | 15.9 | 16.2 | 26.7 |
| 7 | 9.2 | 17.0 | 10.9 | 22.2 | 40.7 |
| 8 | 7.0 | 12.9 | 8.3 | 25.3 | 46.5 |
| 9 | 5.6 | 10.4 | 6.7 | 27.3 | 50.0 |

To synthesize α-LiAlO₂ particles, the reaction mixture compositions shown in Table 2 below were heat-treated at 650° C. As a result, the particles synthesized from all the compositions (composition No. 1-9) were present in a mixed phase of α/β. FIG. 2 shows XRD data for the particles synthesized from these compositions. As can be seen in FIG. 2, in composition Mos. 1 and 2 in which glycerin and triethylene glycol were used alone, the amount of α-LiAlO₂ produced was significantly smaller than that in composition Nos. 3-9 in which the two organic materials were used together. In composition Nos. 3-7 in which the two organic materials were all used, it could be seen that the amounts of glycerin and triethylene glycol influenced the production of α-LiAlO₂ particles upon heat treatment, and as the amounts thereof increased, the peak of α-particles was gradually stronger. From a comparison between composition Nos. 1-7 with composition Nos. 8 and 9, it could be observed that, even when the amounts of organic materials added were increased to a given level or higher (composition No. 8), the peak of α-LiAlO₂ was not increased, whereas, when the organic materials were added in further increased amounts (composition N. 9), the peak of α-LiAlO₂ was relatively decreased. Among the α-/β-LiAlO₂ particles thus synthesized, the particles synthesized from composition No. 7 were heat-treated at 650° C. and 750° C. for 24 hours in an atmosphere of wet CO₂. FIG. 3 shows XRD data for the heat-treated particles. As can be seen in FIG. 3, the CO₂ atmosphere had a significant influence on the growth of α-LiAlO₂ peaks, but the change in temperature had no influence thereon.

Namely, in the method of synthesizing α-LiAlO₂ by adding the organic materials, the addition of the mixed material of glycerin and triethylene glycol had a decisive influence on the increase in the production of α-LiAlO₂. However, when the amounts of glycerin and triethylene glycol added were increased, the production of α-LiAlO₂ was gradually increased, and when the organic materials were added in given amounts or larger, the production of α-LiAlO₂ was decreased rather than increased. Also, when the synthesized α-/β-LiAlO₂ particles were heat-treated at a temperature of 650-750° C. in an atmosphere of wet CO₂, the production of α-LiAlO₂ could be significantly increased, but the influence of the change in temperature on the production of α-LiAlO₂ was insignificant. In conclusion, it is considered that the organic materials added and the CO₂ gas introduced from the outside promoted the crystallization of α-LiAlO₂.

### Example 3

In order to synthesize α-LiAlO₂ through the simplest process without carrying a washing process, Li₂CO₃ and Al(OH)₃ were mixed with each other at a molar ratio of 1:2 without using an electrolyte (K₂CO₃/Na₂CO₃), and the mixture was heat-treated at a temperature range of 500-800° C. for varying period of time, preferably 18-48 hours.

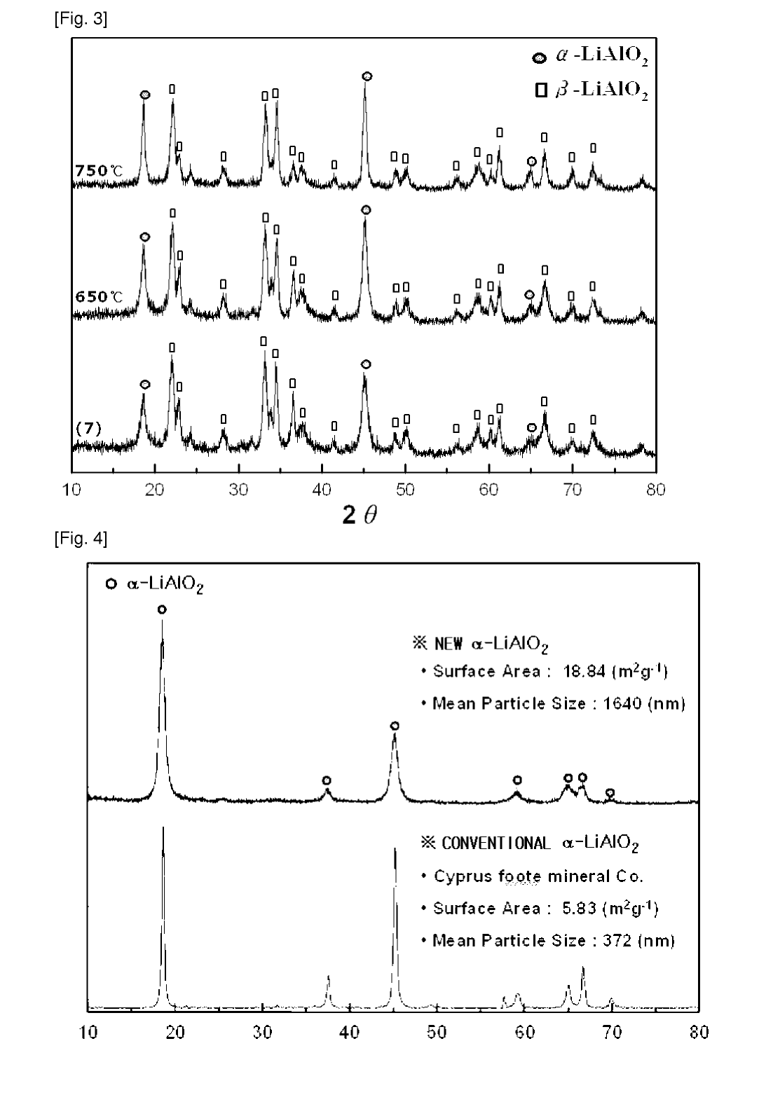

As can be seen from XRD data in FIG. 4, the alpha-lithium alumina prepared according to the present invention consisted of 100% pure α-LiAlO₂ particles.

Namely, according to the present invention, α-LiAlO₂ particles can be prepared at low cost while showing results almost similar to those of alpha-lithium aluminate synthesized according to the prior art.

In short, according to the present invention, high-purity α-LiAlO₂ particles can be synthesized using inexpensive starting materials through a very simple process, and thus the present invention has the effect of greatly reducing production cost.

Specifically, according to the present invention, 100% pure α-LiAlO₂ powder could be synthesized through a simple process using inexpensive starting materials. It was observed that the α-LiAlO₂ particles according to the present invention had a specific surface area which was about 3 times larger and a particle size which was about 5 times larger than those of conventional powder. It can be expected that large particles will assist in increasing the strength of a molten carbonate fuel cell matrix.

### Comparative Example for Example 3

According to a molten salt synthesis method, α-LiAlO₂ particles were synthesized using lithium carbonate Li₂CO₃ instead of LiOH.H₂O. Whether α-LiAlO₂ particles were produced and the properties of the particles were analyzed through XRD patterns. The synthesis of the α-LiAlO₂ particles was carried out using the compositions shown in Table 3, and a fundamental reaction mechanism for synthesizing the α-LiAlO₂ powder is shown in the following equation (5).

Li₂CO₃+2Al(OH)₃→2LiAlO₂+3H₂O+CO₂+2O₂ (5)

TABLE 3

| Composition | Components (wt %) | | | | | Heating Temp./ |
|---|---|---|---|---|---|---|
| No. | Li₂CO₃ | Al(OH)₃ | Di-water | K₂CO₃ | Na₂CO₃ | Time/Atmosphere |
| 10 | 10.6 | 12.2 | 72.0 | 5.2 | — | 600° C./24 h/CO₂ |
| 11 | 10.4 | 12.1 | 71.2 | — | 6.3 | 600° C./24 h/CO₂ |

The α-LiAlO₂ particles were prepared by uniformly mixing the components of Table 3 by ball milling, removing water from the mixture, heat-treating the mixture, and washing the heat-treated mixture with the same washing solution as used in a stability test.

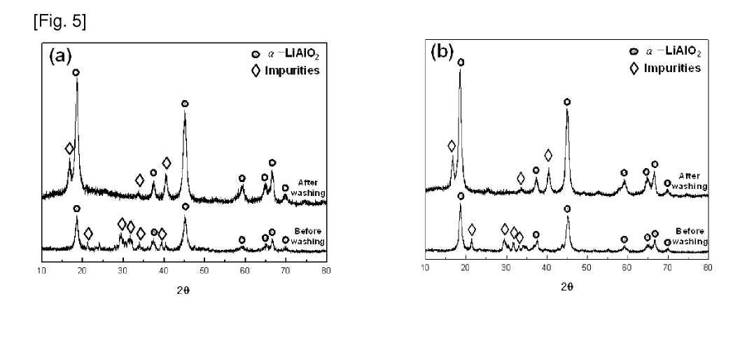

FIGS. 5 (a) and (b) show XRD data for the α-LiAlO₂ particles synthesized from composition Nos. 10 and 11, respectively. As can be seen therein, the peaks of the α-LiAlO₂ particles were very high, suggesting that most of the products were α-LiAlO₂ particles. However, due to the use of the electrolytes (K₂CO₃/Na₂CO₃), a washing process for completely removing these salts was necessarily required. Also, impurities in addition to the α-LiAlO₂ particles were produced.

Although the preferred embodiment of the present invention has been described for illustrative purposes, those skilled in the art will appreciate that various modifications, additions and substitutions are possible, without departing from the scope and spirit of the invention as disclosed in the accompanying claims.

1. A method for preparing alpha-lithium aluminate, which comprises the steps of: mixing Al(OH)₃ with Li₂CO₃ at a molar ratio of from 1:1 to 3:1; and heat-treating the mixture at a temperature range of 500-800° C.

2. The method of claim 1, wherein the step of heat-treating the mixture is carried out in an atmosphere of CO₂.

3. The method of claim 1, wherein the heat-treatment step comprises heating the mixture at a rate of 3-6° C./min and maintaining the mixture in the temperature range.

4. The method of claim 2, wherein the heat-treatment step comprises heating the mixture at a rate of 3-6° C./min and maintaining the mixture in the temperature range.
